(19) United States
(12) Patent Application Publication
(10) Pub. No.: US 2010/0035562 A1
(43) Pub. Date: Feb. 11, 2010

(54) Method and System for Signal Processing and Transmission

(75) Inventors: William P. Alberth, JR., Prairie Grove, IL (US); Richard E. Mach, Cary, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/186,276

(22) Filed: Aug. 5, 2008

(51) Int. Cl. H04Q 7/00

(52) U.S. Cl. 455/75

(57) ABSTRACT

A method, wireless communication device (402) and base station (502) for signal processing and transmission is provided. The method includes detecting (604) simultaneous operation of a radio transmitter of the wireless communication device within a first predefined frequency band and a radio receiver of the wireless communication device within a second predefined frequency band. Further, the method includes reducing (606), based on the detecting, a bandwidth of an operating signal of the radio transmitter from a standard bandwidth value to a reduced bandwidth value. The bandwidth is reduced based on a bandwidth reduction factor. Furthermore, the method includes transmitting (608) the operating signal within the first predefined frequency band from the radio transmitter.

### FIELD OF INVENTION

The present invention relates, in general, to wireless communication devices and more specifically, to a method and system for signal processing and transmission.

### BACKGROUND OF THE INVENTION

Wireless communication devices typically include a radio transceiver for enabling transmission and reception of radio signals for communication. Additionally, satellite receivers can be implemented in a wireless communication device. For example, a Global Positioning System (GPS)-enabled mobile LTE phone can include a transceiver for Long Term Evolution (LTE)-based communication and a satellite GPS receiver. Further, these transmitters and receivers operate in specific frequency bands for transmitting and receiving signals as dictated by government or quasi-governmental bodies such as the U.S. Federal Communications Commission. For example, a GPS-enabled mobile LTE phone may use a 700 MHz frequency band for LTE-based communication and a 1575 MHz frequency band for receiving GPS signals.

Although co-located transmitters and receivers in a single communication device enhance the functionality of the device from a user's standpoint, co-located interference among wireless signals of different operating frequency bands is a cause for concern. This interference problem becomes more prominent when the operating signals of different transmitters and receivers include frequency harmonics of each other, which causes a destructive interference between the signals and reduces the operating signal quality and strength. For example, in a GPS-enabled mobile LTE phone, the transmitted LTE signals of the transmitter can interfere with the received signals of the GPS receiver. In this case, the problem is quite severe because the strength of the GPS signals, received from distant satellites, is very low compared to the strength of the LTE signals. As a result, a destructive interference between these signals further deteriorates the quality and strength of the received GPS signals, and in some cases even de-senses the GPS receiver or completely blocks out the GPS signals. Deterioration of the GPS signals complicates the task of processing these signals for determining the location of the mobile phone.

Presently, a few solutions are available to overcome this problem. In one of the techniques, the modulation of the LTE signals is changed to avoid its interference with GPS signals. However, this technique can have some associated drawbacks. For example, changing the modulation of the signals would require additional circuitry at the receiver to modulate/demodulate the signals according to different modulation techniques. Also, additional hardware is required at the base station to modulate/demodulate the signals according to more than one modulation technique.

Other techniques for reducing deterioration due to interference of signals include: scheduling the operations of transmitters and receivers, changing the transmission frequency of the signals, restricting the change of transmission/reception frequency to some specific frequency, and increasing the linearity of the receivers. Also, for some cases, the amplifier of the GPS receiver can be controlled based on the signal strength of the received GPS signals, or the LTE transmitter can be turned off when the strength of received GPS signals is lower than a threshold value. However, for controlling the amplification according to the signal strength, the signals having very low signal strength may be clipped off or the Signal-to-Noise Ratio (SNR) after amplification can be very low, due to internal noise associated with the amplifier. Also, turning-off the LTE transmitter when the received GPS signal strength is lower than a threshold value may limit the functionality of a wireless communication device.

### BRIEF DESCRIPTION OF THE FIGURES

The accompanying figures, where like reference numerals refer to identical or functionally similar elements throughout the separate figures, and which, together with the detailed description below, are incorporated in and form part of the specification, serve to further illustrate various embodiments and explain various principles and advantages, all in accordance with the present invention.

FIG. 1 illustrates an example environment where various embodiments of the invention can be practiced;

FIG. 2 illustrates an example frequency spectrum distribution scheme of a 700 MHz band, in accordance with various embodiments of the invention;

FIG. 3 illustrates a graph showing the effect of bandwidth reduction of a signal on out-of-band noise of the signal; in accordance with various embodiments of the invention;

FIG. 4 illustrates an example block diagram of a wireless communication device, in accordance with various embodiments of the invention;

FIG. 5 illustrates an example block diagram of a base station, in accordance with various embodiments of the invention;

FIG. 6 illustrates a flow diagram of a method for signal processing and transmission, in accordance with an embodiment of the invention; and

FIG. 7 illustrates a flow diagram of a method for signal processing and transmission, in accordance with another embodiment of the invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

For one embodiment, a method for signal processing and transmission at a wireless communication device includes detecting operation of a radio transmitter of the wireless communication device within a first predefined frequency band simultaneous to operation of a radio receiver of the wireless communication device within a second predefined frequency band. Further, the method includes reducing a bandwidth of an operating signal of the radio transmitter from a standard bandwidth value to a reduced bandwidth value based on the detected simultaneous operation of the transmitter with the receiver. The bandwidth is reduced based on a bandwidth reduction factor. Furthermore, the method includes transmitting the operating signal (at a reduced bandwidth) within the first predefined frequency band from the radio transmitter. In one example, the radio transmitter operates using a radio access technology such as LTE and the radio receiver operates using another radio access technology such as GPS.

In another embodiment, a wireless communication device includes a radio transmitter, a radio receiver, a controller, and a signal processor. The radio transmitter transmits an operating signal within a first predefined frequency band at one of a standard bandwidth value and a reduced bandwidth value. The radio receiver is configured to operate within a second predefined frequency band. The controller is configured to generate an output signal based on detection of simultaneous operation of the radio transmitter within the first predefined frequency band and the radio receiver within the second predefined frequency band. Furthermore, the signal processor is configured to reduce a bandwidth of the operating signal of the radio transmitter from the standard bandwidth value to the reduced bandwidth value based on the output signal. Then, the bandwidth is reduced based on a bandwidth reduction factor to decrease interference between the transmitter and the receiver.

For another embodiment, a method for signal processing and transmission at a base station includes receiving an operating signal from a radio transmitter of a wireless communication device within a first predefined frequency band. Further, the method includes receiving a notification from the wireless communication device that a radio receiver of the wireless communication device is active within a second predefined frequency band. Furthermore, the method includes transmitting a control signal for controlling either a transmission channel or a bandwidth of the operating signal of the radio transmitter of the wireless communication device, based on the receiving an operating signal and receiving the notification. Base station control of the transmission channel and/or bandwidth of the radio transmitter of the wireless communication device under these circumstances can reduce interference between the transmitted signal and the received signal at the wireless communication device.

For yet another embodiment, a base station receiver receives an operating signal from a radio transmitter of a wireless communication device within a first predefined frequency band. Further, the receiver is configured to receive a notification from the wireless communication device that a radio receiver of the wireless communication device is active within a second predefined frequency band. A controller within the base station is configured to generate an output signal based on simultaneous detection of operation of the radio transmitter within the first predefined frequency band and the notification from the wireless communication device. A transmitter of the base station is configured to transmit a control signal for controlling either a transmission channel or a bandwidth of the operating signal of the radio transmitter of the wireless communication device.

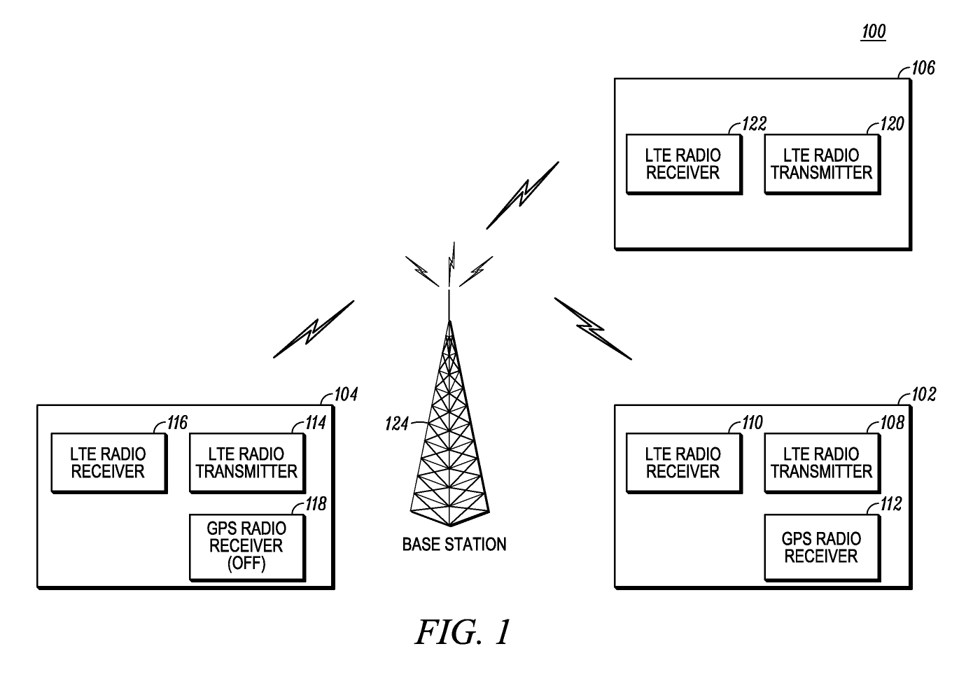

FIG. 1 illustrates an example environment 100 where various embodiments of the invention can be practiced. The environment 100 shown has three wireless communication devices 102, 104, 106. Examples of the wireless communication devices 102, 104, 106 include, but

are not limited to, mobile stations (sometimes called “user equipment”), cellular phones, satellite phones, portable two way radios, Personal Digital Assistants (PDAs), Ham radios, and Wi-Fi enabled devices. Further, depending on the functionality, some of these communication devices can include multiple radio transceivers. For example, a PDA or a smart phone can include a cellular telecommunication transceiver for LTE telecommunication and a Global Positioning System (GPS) receiver for location determination, as well as a WLAN transceiver and other components.

In such cases, an LTE radio transmitter in a communication device 102 can generate a powerful signal, which is interpreted as a significant amount of noise by a GPS radio receiver within the same communication device 102. The signals of an LTE radio transmitter of one communication device 102 can also hinder the performance of a GPS radio receiver of other, nearby communication devices 104, 106.

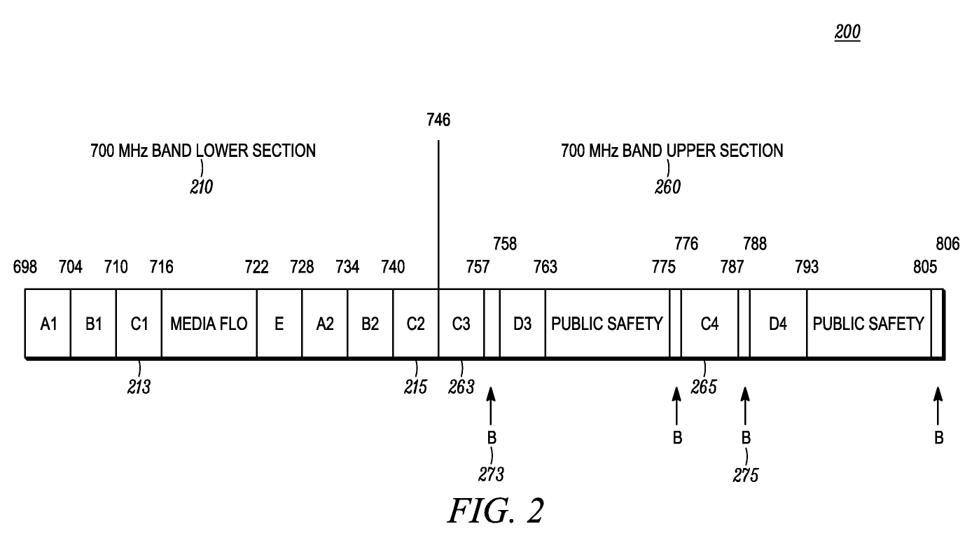

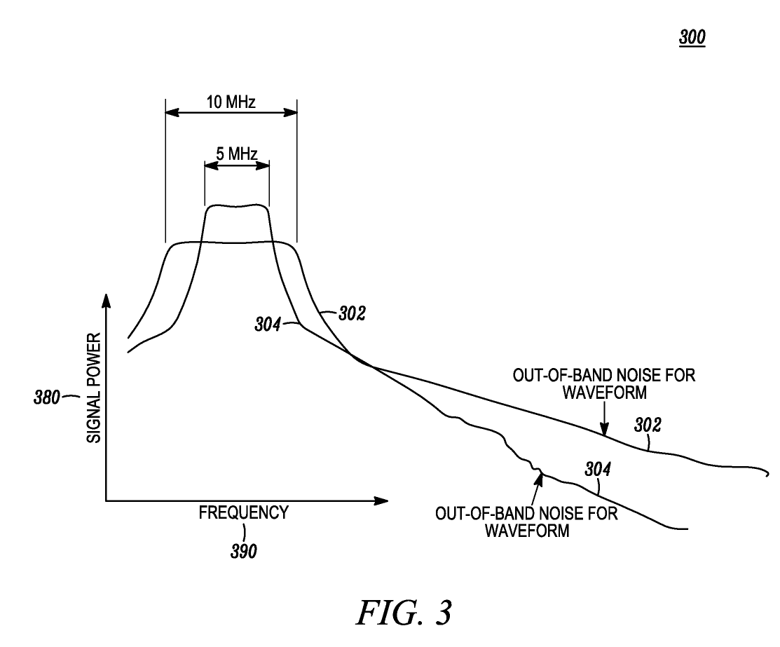

Typically, different types of radio devices operate in different frequency bands and have different operating signals. These operating signals have different bandwidths, multiple communication protocols (such as time division, code division, and frequency division), data rates, signal ranges, and performance characteristics. Different radio devices operating simultaneously in close vicinity to each other, either in the same communication device or in different communication devices, may adversely affect the quality or processing of the corresponding operating signals. For example, an LTE radio transmitter can adversely affect the quality of the GPS signals received by a GPS radio receiver in close vicinity to the LTE radio transmitter, due to harmonic interference between the LTE and GPS signals. This will be described in detail in conjunction with FIGS. 2 and 3.

As illustrated in FIG. 1, the wireless communication device 102 includes an LTE radio transmitter 108, an LTE radio receiver 110, and a GPS radio receiver 112. Similarly, the wireless communication device 104 includes an LTE radio transmitter 114, an LTE radio receiver 116, and a GPS radio receiver 118. The environment can also include wireless communication devices whose functionality is limited to only enabling LTE based wireless communication. For example, the wireless communication device 106 includes an LTE radio transmitter 120 and an LTE radio receiver 122 for enabling wireless communication but no GPS receiver. The environment also includes a base station 124 primarily used for facilitating LTE-based wireless communication with various compatible wireless communication devices in its network coverage area.

For one embodiment, both the LTE and GPS radio components of the wireless communication device 102 can be active at the same time. The LTE radio transmitter 108 and the GPS radio receiver 112 operate in different frequency bands, in accordance with the LTE and GPS system requirements for their respective operational frequency bands. For example, the LTE radio transmitter 108 operates within a first predefined frequency band (e.g., 776-787 MHz) and the GPS radio receiver 112 operates within a second predefined frequency band (e.g., 1575-1576 MHz).

In such a case, the second predefined frequency band of the radio receiver includes a frequency harmonic of an operating signal of the LTE radio transmitter 108. From a purely theoretical perspective, twice 787.5 MHz equals 1575 MHz, thus the GPS receiving band is a second harmonic of some frequencies next to the LTE transmission band. Any out-of-band noise or sideband transmission from the LTE system will thus impinge into the GPS receiving band at the second harmonic. More detail regarding the actual frequencies of the second harmonic of the LTE transmission band will be provided with respect to FIG. 2. Due to the presence of a frequency harmonic of the operating signal of the LTE radio transmitter 108 in the frequency band of the GPS radio receiver 112, harmonic interference between LTE and GPS signals can result in deterioration of strength and quality of received GPS signals. This in turn complicates the process of detecting and processing GPS signals at the communication device 102.

The operating signals transmitted by the LTE radio transmitters of other wireless communication devices in the vicinity of the communication device 102 can also affect the performance of the GPS radio receiver 112 of the communication device 102. For example, as illustrated in FIG. 1, the operating signals transmitted by LTE radio transmitters 114 and 120 of the communication devices 104 and 106 respectively, can cause harmonic interference with GPS signals received by the GPS radio receiver 112 of the communication device 102. Further, the operating signals transmitted by the LTE radio transmitter 114 of the communication device 104 may not affect the GPS radio receiver 118 within the same communication device, if the GPS radio receiver 118 is not simultaneously active with the LTE radio transmitter 114. This has been illustrated in FIG. 1 with the term “OFF” in box 118 indicating that it is temporarily in an ‘OFF’ state.

It will be apparent to a person skilled in the art that this embodiment has been explained using LTE and GPS based systems (LTE radio transmitter and GPS radio receiver) as an example for the sake of clarity of the description. The proposed methodology for signal processing and transmission can be implemented in various other environments and systems for reducing out-of-band noise of a signal or harmonic interference between signals, without deviating from the scope of the invention. Also, the ranges of the first and the second predefined frequency bands, mentioned as an example in the description, can be appropriately adjusted based on the environment for implementation of the invention.

Examples of other types of wireless systems where the invention may be implemented, with suitable modifications without deviating from the scope of the invention, include Code Division Multiple Access (CDMA) networks, Wireless Local Area (WLAN), Advanced Mobile Phone System (AMPS), Worldwide interoperability for Microwave Access (WiMAX) systems, Bluetooth® and other communication systems as well as LOng Range Navigation (LORAN), Galileo, and other positional systems. Although one base station and three wireless communication devices have been depicted in FIG. 1, it will be apparent to a person skilled in the art that the environment can include any number of base stations and wireless communication devices, as may be required for any commercial implementation.

FIG. 2 illustrates an example frequency band distribution spectrum 200, in accordance with various embodiments of the invention. This frequency band distribution spectrum 200 reflects current U.S. Federal Communications Commission wireless spectrum allocation for the 700 MHz band and illustrates the distribution of frequencies into different sub-bands in a frequency band from 698 MHz to 806 MHz. In accordance with this embodiment, the frequency band from 698 MHz to 806 MHz is split into a lower section 210 and an upper section 260. The lower section 210 ranges from 698 MHz to 746 MHz. The upper section ranges from 746 MHz to 806 MHz. Further, some frequency sub-bands in the lower and upper sections are allocated for wireless telecommunication. Similarly, frequency sub-band 716 MHz to 722 MHz is allocated to broadcasting based communication, for example Media FLO™. Also, sub-bands 763 MHz to 775 MHz and 794 MHz to 805 MHz are allocated to public safety based communications pending auction.

Referring to FIG. 2, frequency sub-bands C1 213 and C2 215, in the lower section 210 and frequency sub-bands C3 263 and C4 265, in the upper section 260, are assigned for wireless communication systems. In the lower section, frequency sub-band C1 213 ranges from 710 MHz to 716 MHz and frequency sub-band C2 215 ranges from 740 MHz to 746 MHz. Similarly, in the upper section 260, frequency sub-band C3 263 ranges from 746 MHz to 757 MHz and frequency sub-band C4 265 ranges from 776 MHz to 787 MHz. Examples of the wireless communication systems to which these frequency sub-bands can be allocated to include, but are not limited to, Global System for Mobile Communication (GSM) networks, Code Division Multiple Access (CDMA) networks, Wireless Local Area Networks (WLANs), Advanced Mobile Phone Systems (AMPS), WiMAX™, and LTE.

Further, frequency sub-bands labeled B 273, 275 (757-758 MHz, and 787-788 MHz) are band-gaps (or guard bands) for the upper band limits corresponding to the frequency sub-bands C3 263 and C4 265 respectively. For one embodiment, a first predefined frequency band (776 MHz to 787 MHz), as described in conjunction with FIG. 1, can include the frequency sub-band C4 265 (776 MHz to 787 MHz). Similarly, the second predefined frequency band, as described in conjunction with FIG. 1, can include a frequency band with the GPS frequency signal (1575.42 MHz). In this embodiment, the band gap A 275 can include the 787.71 MHz frequency component, which is half of the GPS signal frequency (1575.42 MHz).

Consequently, harmonic interference can occur between, for example, an LTE signal transmitting in the C4 265 frequency block and a GPS signal. The harmonic interference is caused due to spillage of out-of-band noise of the LTE signal into the frequency band including transmit power near 787.71 MHz, whose second harmonic falls in the GPS signal frequency band (1575.42 MHz). The second harmonic of the modulated LTE waveform is wider then the first fundamental transmit signal. Thus, noise from the sidebands of the second harmonic signal will impinge on the GPS frequency of 1575.42 MHz resulting in degraded performance of the GPS receiver.

FIG. 3 illustrates a graph showing the effect of bandwidth reduction of a signal on out-of-band noise of the signal, in accordance with various embodiments of the invention. Ideally, signal filters in a communication device should block all frequencies for a signal which falls outside a desired frequency band. For example, after passing through a band-pass filter, a signal in the desired frequency band of 776 MHz to 787 MHz should only include the frequency components between the range of 776 MHz to 787 MHz. However, due to limitations of performance of signal filters and power amplifiers, some energy of the signal is spilled in adjacent frequency bands, outside the desired frequency band. The limitation of the performance of a filter arises due to an associated frequency roll-off rate. In order to overcome this limitation, the bandwidth of a signal can be reduced.

Referring to FIG. 3, a graphical representation of ‘signal power’ 380 versus ‘frequency’ 390 is illustrated for a typical OFDM LTE signal. Of course, this signal is being used for demonstration purposes and other signals can be substituted to show the same effect. Waveform 302 represents the OFDM signal resulting after being processed by a band-pass filter, using a standard bandwidth value. Similarly, waveform 304 represents the signal when its bandwidth is decreased to a reduced bandwidth value, after being processed by a band-pass filter. In the example for reducing signal bandwidth illustrated in FIG. 3, the signal bandwidth is reduced from a standard bandwidth value of 11 MHz to a reduced bandwidth value of 5 MHz. For one embodiment, a bandwidth reduction factor indicates the ratio of the reduced bandwidth value and the standard bandwidth value. The ratio may be represented in decimal form or in percentage form. The bandwidth could alternately be reduced from 11 MHz to 1.4 MHz.

Referring to FIG. 3, it can be observed that when the bandwidth of the signal is reduced from a standard bandwidth value (depicted by waveform 302) to a reduced bandwidth value (depicted by waveform 304), the peak power level of the signal increases. Further, the average power distribution of the signal across the bandwidth remains constant for both the cases. The average power distribution of a signal is determined by the area under the curve of a waveform of the signal, as represented in a ‘signal power’ versus ‘frequency’ graph 300.

As is evident from FIG. 3, the waveform 304 has a narrower occupied bandwidth and a relatively faster drop off in out-of-band power. This results in lower out-of-band noise associated with the waveform 304. In comparison, the waveform 302 has a larger occupied bandwidth, resulting in higher out-of-band noise associated with the waveform 302. Further, although there is an increase in the peak signal power for the waveform 304, the average signal power across the bandwidth of the waveform 304 remains the same as for the waveform 302. Hence, relatively less spectral energy is spilled outside the desired frequency band of a signal with reduced bandwidth value (e.g., 1.4 MHz or 5 MHz for LTE), as compared to that of a signal with standard bandwidth value (e.g., 11 MHz for LTE). This also results in less energy to interfere with the GPS signal at approximately 1575 MHz.

Due to the reduced out-of-band noise associated with a signal 304 with reduced bandwidth value, harmonic interference can be reduced. For example, referring to FIG. 2, due to out-of-band noise, an operating signal in the sub-band C4 (776 MHz to 787 MHz) may spill some energy outside this band, into the adjacent band-gaps B (775 MHz to 776 MHz) and A (787 MHz to 788 MHz). Further, the band-gap A includes a frequency component (787.71 MHz) which is half of the GPS signal frequency (1575.42 MHz). Due to the spilled energy of the operating signal into the band-gap A, a radio transmitter may transmit an operating signal has a frequency harmonic (second harmonic) in the GPS frequency band. Presence of the second harmonic of the spilled energy of the operating signal can deteriorate the strength and quality of the GPS signals received at a GPS radio receiver.

When the bandwidth of the operating signal in the sub-band C4 is reduced, however, the out-of-band noise associated with the signal will also decrease, even though the average transmitted power remains constant. Consequently, the amount of spilled energy of the operating signal into the band-gap A can be reduced. This can in turn result in substantially decreasing or eliminating the presence of frequency harmonics of the spilled energy of operating signal in GPS frequency band.

Further, the reduction in bandwidth of a signal may not necessarily be symmetric about a carrier signal frequency. For example, in accordance with Orthogonal Frequency Division Multiplexing (OFDM) methodology of signal processing, the reduction in bandwidth of a signal can be asymmetric. In such cases, the bandwidth on only one of the band-edges of a signal can be reduced. This can be implemented by blocking resource blocks of, for example, only specific higher frequencies as enabled by WiMax specifications (IEEE 802.16e) or LTE specifications (3GPP.org).

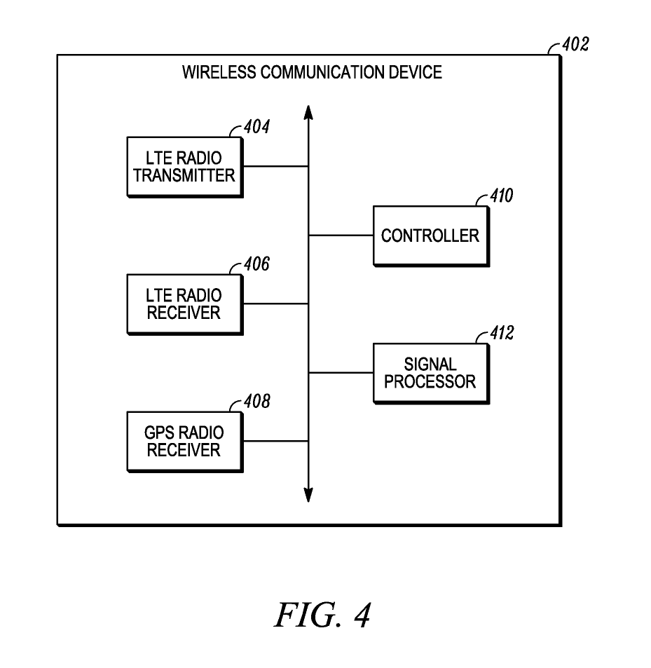

FIG. 4 illustrates an example block diagram of a wireless communication device 402, in accordance with an embodiment of the present invention. To describe FIG. 4, references will be made to FIGS. 1, 2, and 3 for the sake of clarity, although it will be apparent to those skilled in the art that the system can also be implemented in any other suitable environment. The wireless communication device 402 includes an LTE radio transmitter 404, an LTE radio receiver 406, a GPS radio receiver 408, a controller 410, and a signal processor 412. The wireless communication device 402 can be, for example, a GPS enabled mobile phone, cellular phone, satellite phone, portable two-way radio, or wireless Personal Digital Assistant (PDA).

For one embodiment, the LTE radio transmitter 404 and the LTE radio receiver 406 can be configured to enable LTE-based communication for the wireless communication device 402. The LTE radio transmitter 404 and the LTE radio receiver 406 can communicate with a base station, by transmitting and receiving an operating signal. Further, the operating signal can be within a first predefined frequency band, for example, within a frequency range of 776 MHz to 787 MHz. Further, the operating signal can have a standard bandwidth value, such as 11 MHz for LTE, used for processing the operating signal at the communication device or the base station.

The wireless communication device also includes an additional radio receiver, the GPS radio receiver 408, which can be used for receiving positioning information from positional system satellites operating within a second predefined frequency band. The second predefined frequency band can be within a frequency range of 1575 MHz to 1576 MHz. GPS signals carrying positional data are received from distant satellites, and hence, are comparatively much weaker than LTE signals received from a terrestrial base station. Hence, presence of any noise in the GPS signals due to harmonic interference with LTE signals can substantially deteriorate the strength and quality of the received GPS signals.

As described in conjunction with FIGS. 1, 2, and 3, harmonic interference can be caused when the LTE radio transmitter 404 and the GPS radio receiver 408 are simultaneously active. Also, even if only the LTE radio transmitter 404 is active within the first predefined frequency band, performance of other GPS radio receivers, in the vicinity of the LTE radio transmitter 404, may be adversely affected. For one embodiment, the controller 410 can be configured to generate an output signal based on detection of simultaneous operation of the LTE radio transmitter 404 within the first predefined frequency band and the GPS radio receiver 408 within the second predefined frequency band. For another embodiment, the controller 410 can be configured to generate an output signal based only on detection of operation of the LTE radio transmitter 404 within the first predefined frequency band.

Further, based on the output signal, the signal processor 412 can be configured to reduce the bandwidth of the operating signal of the LTE radio transmitter 404 from a standard bandwidth value to a reduced bandwidth value. The bandwidth is reduced based on a bandwidth reduction factor. The bandwidth reduction factor can indicate the ratio of the reduced bandwidth value and the standard bandwidth value (e.g., half). The ratio may also be represented in decimal form (e.g., 0.5) or in percentage form (e.g., 50). Alternately the bandwidth may be reduced to a specified amount (e.g., 5 MHz, 1.4 MHz, or other values). Other factors that may affect the bandwidth reduction factor include quality metrics of a signal, for example, out-of-band interference value associated with the signal, number of satellites captured, bit-error-rate of the signal, and/or the strength indication of the signal.

After the bandwidth of the operating signal of the LTE radio transmitter 404 is decreased to a reduced bandwidth value, the LTE radio transmitter 404 can be configured to transmit the operating signal at the reduced bandwidth value, within the first predefined frequency range. For example, the operating signal of the LTE radio transmitter 404 can have a standard bandwidth value of, say, 11 MHz, within the first predefined frequency band. However, based on the output signal, the signal processor 412 can reduce the bandwidth of the operating signal from a standard bandwidth value of 11 MHz to a reduced bandwidth value of, say, 5 MHz.

In such cases, a base station can be configured to detect and receive the operating signal at the reduced bandwidth value, transmitted from the LTE radio transmitter 404. For one embodiment, detecting the operating signal at reduced bandwidth at the base station can include performing a joint-detection of the multiple bandwidth formats of the operating signal transmitted from the wireless communication device 402. Further, a scheduler in the network can be updated corresponding to the reduced bandwidth value of the operating signal.

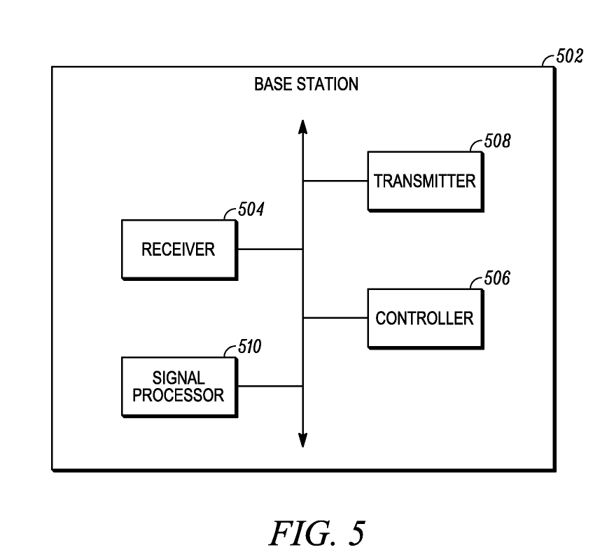

FIG. 5 illustrates an example block diagram of a base station 502, in accordance with various embodiments of the present invention. To describe FIG. 5, references will be made to FIGS. 1, 2, 3, and 4, for the sake of clarity, although it will be apparent to those skilled in the art that the system can also be implemented in any other suitable environment. The base station 502 can be configured to operate in accordance with a Global System for Mobile Communication (GSM) network, Code Division Multiple Access (CDMA) network, Wireless Local Area Network (WLAN), Advanced Mobile Phone System (AMPS), WiMAX, LTE, or the like. The base station 502 facilitates communication between different wireless communication devices within its network coverage area. Further, the base station 502 can perform functionalities like encrypting and decrypting communications, spectrum filtering of signals, processing of signals, etc. For one embodiment, the base station 502 includes a receiver 504, a controller 506, a transmitter 508, and a signal processor 510.

The receiver 504 can be configured to receive an operating signal from a radio transmitter of a wireless communication device. For example, the receiver 504 can receive the operating signal transmitted from the LTE radio transmitter 404 of the wireless communication device 402. Further, the operating signal can be within a first predefined frequency range of 776 MHz to 787 MHz. The signal processor 412 can process the received operating signal from the wireless communication device 402.

For some cases, a user of the wireless communication device 402 simultaneously activates the LTE radio transmitter 404, along with the GPS radio receiver 408. The wireless communication device 402 can be configured to send out a notification to the base station 502, whenever its GPS radio receiver 408 is active within the second predefined frequency band of 1575 MHz to 1576 MHz, along with the LTE radio transmitter 404 being active in the first predefined frequency band of 776 MHz to 787 MHz. The notification can indicate to the base station 502 that the GPS radio receiver 408 and the LTE radio transmitter 404 are simultaneously active within the second and first predefined frequency bands respectively. The notification can also contain a bandwidth reduction factor, as explained later in the description. The receiver 504 can receive the notification from the wireless communication device 402.

For one embodiment, the controller 506 generates an output signal based on the reception of the notification from the wireless communication device 402. For another embodiment, the controller 506 can be configured to generate the output signal based on the detection of operation of the LTE radio transmitter 404 near the 787.71 MHz frequency, within the first predefined frequency band.

As described in detail in conjunction with FIGS. 1, 2, 3, and 4, when the LTE radio transmitter 404 and the GPS radio receiver 408 are simultaneously active, within the first and the second predefined frequency bands respectively, harmonic inference can adversely affect the signal strength and quality of GPS signals received at the communication device 402. Also, if the LTE radio transmitter 404 is active near the 787.71 MHz frequency, within the first predefined frequency band, the operation of other GPS radio receivers in the vicinity of the LTE radio transmitter 404 may be adversely affected.

To overcome this problem, the transmitter 508 can be configured to transmit a control signal for controlling one of a transmission channel and a bandwidth of the operating signal of the LTE radio transmitter 404, based on the output signal from the controller 506. For one embodiment, the control signal can be transmitted based on the notification from the communication device 402. For another embodiment, the control signal can be transmitted based on only the reception of the LTE operating signal from the communication device 402.

For some cases, the control signal can include an instruction to assign a different operating frequency band to the LTE radio transmitter 404. For example, the LTE radio transmitter 404 typically operates in the first predefined frequency band of 776 MHz to 787 MHz. However, the base station 502 can send a control signal to the communication device 402 to reassign the LTE radio transmitter 404 to a different frequency band, for example the AWS band (1710-1755 MHz). For some cases, the control signal can include an instruction to restrict access of the LTE radio transmitter 404 to the first predefined frequency band for a predefined duration of time, for example, one second. In such cases, the LTE radio transmitter 404 can suspend its operations for the specified time duration so that it is not concurrently active with the GPS radio receiver 408.

For some cases, when Orthogonal Frequency Division Multiplexing (OFDM) signal multiplexing technique is used, the control signal can include an instruction instructing the base station 502 to restrict allocation of one or more resource blocks for signal transmission for the LTE radio transmitter 404 as defined in specifications such as LTE. Typically, OFDM modulation technique uses resource blocks (sub-carriers) defined in terms of time and frequency domain, to enable signal transmission. Based on the control signal, the signal processor 510 can allocate only those resource blocks which will not cause any harmonic interference with the signals received at the GPS radio receiver 408. For example, the signal processor 510 can restrict allocation of resource blocks near the half GPS frequency (787.71 MHz), within the first predefined frequency band. Further, in such cases, a scheduler in the network can be updated corresponding to the restrictions/reallocation of the resource blocks for the operating signal of the LTE radio transmitter 404.

For some cases, the control signal can instruct the communication device 402 to reduce the bandwidth of the operating signal of the LTE radio transmitter 404 from a standard bandwidth value to a reduced bandwidth value. Further, the bandwidth is reduced based on a bandwidth reduction factor, as described in conjunction with FIGS. 3 and 4. For example, on receiving the control signal from the base station 502, the signal processor 412 can reduce the bandwidth of the operating signal from the standard bandwidth value of 11 MHz to a reduced bandwidth value of 5 MHz. In such cases, the signal processor 510 of the base station can be configured to update a scheduler in the communication network corresponding to the reduced bandwidth value of the operating signal of the LTE radio transmitter 404. Further, the receiver 504 can be configured to detect the operating signal at the reduced bandwidth value. For one embodiment, detecting the operating signal at reduced bandwidth can include performing a joint-detection at the base station 502 of the multiple bandwidth formats of the operating signal transmitted from the wireless communication device 402.

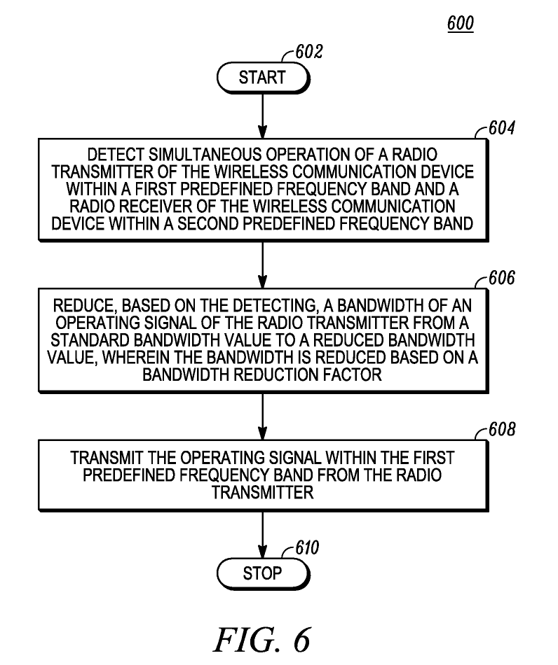

FIG. 6 illustrates a flow diagram 600 of a method for signal processing and transmission at the wireless communication device 402, in accordance with an embodiment of the present invention. To describe FIG. 6, references will be made to FIGS. 1, 2, 3, 4, and 5, for the sake of clarity, although it will be apparent to those skilled in the art that the method can also be implemented in any other suitable environment. The method for signal processing and transmission at the wireless communication device 402 is initiated at step 602. At step 604, simultaneous operation of a radio transmitter of the wireless communication device 402 within a first frequency band and a radio receiver of the wireless communication device 402 within a second predefined frequency band is detected. For one embodiment, the first predefined frequency band can be within a frequency range of 776 MHz to 787 MHz, and the second predefined frequency band can be within a frequency range of 1575 MHz to 1576 MHz. Further, the second predefined frequency band can include a frequency harmonic of the operating signal of the radio transmitter near the first predefined frequency band.

At step 606, a bandwidth of an operating signal of the radio transmitter is reduced from a standard bandwidth value to a reduced bandwidth value. For one embodiment, the bandwidth of the operating signal can be reduced based on the detection of the simultaneous operation of the radio transmitter and the radio receiver, as explained at step 604. For another embodiment, the bandwidth of the operating signal can be reduced based on the detection of operation of the radio transmitter near 787.71 MHz frequency, within the first predefined frequency band. Further, the bandwidth of the operating signal of the radio transmitter is reduced based on a bandwidth reduction factor. For one embodiment, the bandwidth reduction factor can be based on an out-of-band interference value associated with the operating signal, and signal quality metrics for a signal received at the radio receiver. Further, reducing the bandwidth of the operating signal can include maintaining a constant signal power distribution value of the operating signal within the first predefined frequency band.

At step 608, the operating signal at the reduced bandwidth value is transmitted from the radio transmitter within the first predefined frequency band. For one embodiment, the operating signal can be transmitted at the standard bandwidth value when the operation of the radio transmitter is detected to be outside the first predefined frequency band. The method for signal processing and transmission at the wireless communication device 402 is terminated at step 610. [INVRs: Is sending the control signal cumulative to reducing the BW in step 606 or is it a separate (mutually-exclusive) alternative?]

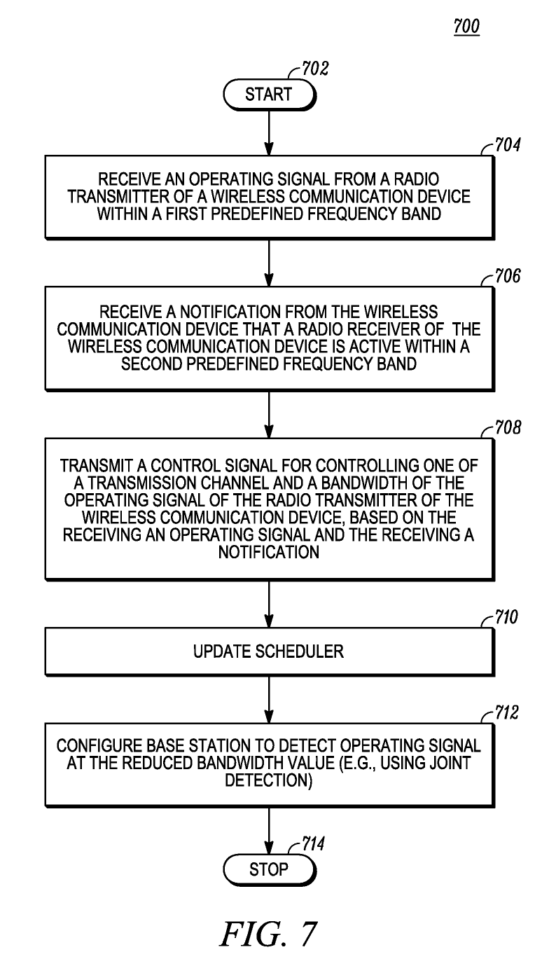

FIG. 7 illustrates a flow diagram 700 of a method for signal processing and transmission at the base station 502, in accordance with another embodiment of the present invention. To describe FIG. 7, references will be made to FIGS. 1, 2, 3, 4, and 5, for the sake of clarity, although it will be apparent to those skilled in the art that the method can also be implemented in any other suitable environment. The method for signal processing and transmission at the base station 502 is initiated at step 702. At step 704, an operating signal, within a first predefined frequency band, is received at the base station 502 from a radio transmitter of a wireless communication device. For one embodiment, the first predefined frequency band can be within a frequency range of 776 MHz to 787 MHz.

At step 706, a notification is received at the base station 502 from the wireless communication device. The notification can indicate that a radio receiver of the wireless communication device is active within a second predefined frequency band. For one embodiment, the second predefined frequency band can be within a frequency range of 1575 MHz to 1576 MHz. Further, the second predefined frequency band can include a frequency harmonic of the operating signal near the first predefined frequency band.

At step 708, a control signal can be transmitted from the base station 502, based on the notification from the wireless communication device. The control signal can be configured to control either a transmission channel or a bandwidth of the operating signal of the radio transmitter of the wireless communication device. For one embodiment, the control signal can include an instruction to assign a different operating frequency band to the radio transmitter. For another embodiment, the control signal can include an instruction to restrict access of the radio transmitter of the wireless communication device to the first predefined frequency band, for a predefined duration of time, for example, one second. When an Orthogonal Frequency Division Multiplexing (OFDM) signal multiplexing technique is implemented in the network, the control signal can include an instruction to restrict allocation of one or more resource blocks for signal transmission for the radio transmitter.

For some cases, the control signal can include an instruction to reduce, at the wireless communication device, the bandwidth of the operating signal of the radio transmitter from a standard bandwidth value to a reduced bandwidth value. Further, the bandwidth is reduced based on a bandwidth reduction factor. The bandwidth reduction factor is based on an out-of-band interference value associated with the operating signal. Other factors that may affect the bandwidth reduction factor include quality metrics of a signal, for example, out-of-band interference value associated with the signal, bit-error-rate of the signal, and/or the strength indication of the signal.

Further, when the bandwidth of the operating signal of the radio transmitter is reduced, based on the control signal, a scheduler in a network can be updated in step 710 corresponding to the reduced bandwidth value of the operating signal. Also, the base station 502 can be configured in step 712 to detect the operating signal at the reduced bandwidth value. For one embodiment, detecting the operating signal at the reduced bandwidth can include performing a joint detection, at the base station, of multiple bandwidth formats of the operating signal, transmitted from the wireless communication device. At step 714, the method for signal processing and transmission at the base station 502 is terminated.

Various embodiments of the present invention provide a method, wireless communication device and base station for signal processing and transmission. With the upcoming availability of the 700 MHz radio frequency spectrum for wireless communications, harmonic interference between wireless communications signals near the 787.71 MHz frequency and Global Positioning System (GPS) signals near 1575.42 MHz frequency is a cause of concern. This can lead to more severe problems for communication devices having co-located wireless communication radio transmitters and GPS radio receivers. Given that GPS signals, received from distant satellites, are substantially weaker in strength as compared to wireless communications operating signals, deterioration of GPS signals quality can lead to de-sensing or blocking of a GPS radio receiver.

The invention proposes an efficient method to reduce the destructive harmonic interference between two signals, by reducing energy spill-over to adjacent bands, outside a desired bandwidth of a signal. The method proposes to reduce the bandwidth of an operating signal of the radio transmitter at a communication device, either autonomously, or on receiving instructions from a base station. Further, the solution proposed by the invention not only helps reducing the harmonic interference in a GPS radio receiver co-located with the radio transmitter, but also in other GPS receivers in close vicinity of the radio transmitter.

Further, as will be evident from the description, the proposed methodology of signal processing and transmission, can be implemented in various other environments and systems for reducing out-of-band noise of a signal or harmonic interference between signals, without deviating from the scope of the invention.

It will be appreciated that the method for signal processing and transmission described herein may include one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power-source circuits, and user-input devices. As such, these functions may be interpreted as steps of a method signal processing and transmission. Alternatively, some or all of the functions can be implemented by a state machine that has no stored program instructions, or in one or more application-specific integrated circuits (ASICs), in which each function, or some combinations of certain of the functions, are implemented as custom logic. Of course, a combination of the two approaches could also be used. Thus, methods and means for these functions have been described herein.

The present invention resides primarily in combinations of method steps related to the method and system for signal processing and transmission. Accordingly, the apparatus components and method steps have been represented, where appropriate, by conventional symbols in the drawings showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article or apparatus that comprises a list of elements does not include only those elements but can include other elements not expressly listed or inherent to such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The term “includes”, as used herein, is defined as comprising.

It is expected that one with ordinary skill, notwithstanding possibly significant effort and many design choices motivated by, for example, available time, current technology and economic considerations, when guided by the concepts and principles disclosed herein, will be readily capable of generating such instructions, programs and ICs with minimal experimentation.

In the foregoing specification, the invention and its benefits and advantages have been described with reference to specific embodiments. However, one with ordinary skill in the art would appreciate that various modifications and changes can be made without departing from the scope of the present invention, as set forth in the claims below. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims as issued.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method at a wireless communication device comprising:
detecting simultaneous operation of a radio transmitter of the wireless communication device within a first predefined frequency band and a radio receiver of the wireless communication device within a second predefined frequency band;
reducing, based on the detecting, a bandwidth of an operating signal of the radio transmitter from a standard bandwidth value to a reduced bandwidth value; and
transmitting the operating signal within the first predefined frequency band from the radio transmitter using the reduced bandwidth value.

2. The method as recited in claim 1, wherein the second predefined frequency band is within a frequency range of 1575 MHz to 1576 MHz.

3. The method as recited in claim 2, wherein the first predefined frequency band is within a frequency range of 776 MHz to 787 MHz.

4. The method as recited in claim 1, wherein the second predefined frequency band includes a frequency harmonic of the operating signal of the radio transmitter.

5. The method as recited in claim 1, wherein the reducing is based on a bandwidth reduction factor that is based on one or more of: an out-of-band interference value associated with the operating signal and signal quality metrics for a signal received at the radio receiver,

6. The method as recited in claim 1, wherein reducing the bandwidth of the operating signal comprises:
maintaining a constant signal power distribution value of the operating signal within the first predefined frequency band.

7. The method as recited in claim 1 further comprising:
transmitting the operating signal using the standard bandwidth value when the operation of the radio transmitter is outside the first predefined frequency band.

8. A method at a base station comprising:
receiving an operating signal from a radio transmitter of a wireless communication device within a first predefined frequency band;
receiving a notification from the wireless communication device that a radio receiver of the wireless communication device is active within a second predefined frequency band; and
transmitting, based on the receiving an operating signal and the receiving a notification, a control signal for controlling one of: a transmission channel and a bandwidth of the operating signal of the radio transmitter of the wireless communication device.

9. The method as recited in claim 8, wherein the first predefined frequency band is within a frequency range of 776 MHz to 787 MHz.

10. The method as recited in claim 8, wherein the second predefined frequency band includes a frequency harmonic of the operating signal.

11. The method as recited in claim 8, wherein the control signal comprises:
an instruction assigning a different operating frequency band to the radio transmitter.

12. The method as recited in claim 8, wherein the control signal comprises:
an instruction restricting access of the radio transmitter to the first predefined frequency band for a predefined duration of time.

13. The method as recited in claim 8, wherein the control signal comprises:
an instruction restricting allocation of one or more resource blocks for signal transmission for the radio transmitter.

14. The method as recited in claim 8, wherein the control signal comprises:
an instruction to reduce, at the wireless communication device, the bandwidth of the operating signal of the radio transmitter from a standard bandwidth value to a reduced bandwidth value, wherein the bandwidth is reduced based on a bandwidth reduction factor.

15. The method as recited in claim 14, wherein the bandwidth reduction factor is based on an out-of-band interference value associated with the operating signal.

16. The method as recited in claim 14 further comprising:
updating a scheduler in a network corresponding to the reduced bandwidth value of the operating signal of the radio transmitter.

17. The method as recited in claim 14 further comprising:
detecting the operating signal at the reduced bandwidth value at the base station.

18. The method as recited in claim 17, wherein detecting the operating signal at the reduced bandwidth value comprises:
performing a joint detection at the base station of multiple bandwidth formats of the operating signal transmitted from the wireless communication device.

19. A wireless communication device comprising:
a radio transmitter configured to transmit an operating signal within a first predefined frequency band with a constant signal power distribution value at one of a standard bandwidth value and a reduced bandwidth value;
a radio receiver configured to operate within a second predefined frequency band;
a controller configured to generate an output signal based on detection of simultaneous operation of the radio transmitter within the first predefined frequency band and the radio receiver within the second predefined frequency band; and
a signal processor configured to reduce a bandwidth of the operating signal of the radio transmitter from the standard bandwidth value to the reduced bandwidth value based on the output signal.

20. A base station comprising:
a receiver configured to:
receive an operating signal from a radio transmitter of a wireless communication device within a first predefined frequency band; and
receive a notification from the wireless communication device that a radio receiver of the wireless communication device is active within a second predefined frequency band; and
a controller configured to:
generate an output signal based on simultaneous detection of operation of the radio transmitter within the first predefined frequency band and the notification from the wireless communication device; and
a transmitter configured to:
transmit, based on the receiving an operating signal and the receiving a notification, a control signal for controlling one of: a transmission channel and a bandwidth of the operating signal of the radio transmitter of the wireless communication device.
